(19) United States
(12) Patent Application Publication
(10) Pub. No.: US 2013/0258264 A1
(43) Pub. Date: Oct. 3, 2013

(54) LIQUID CRYSTAL DISPLAY DEVICE

(71) Applicants: INNOCOM TECHNOLOGY (SHENZHEN) CO., LT, Shenzhen City (CN); CHIMEI INNOLUX CORPORATION, Chu-Nan (TW)

(72) Inventors: Cheng-Chung PENG, Chu-Nan (TW); Shih-Hung FAN, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/673,877

(22) Filed: Nov. 9, 2012

(30) Foreign Application Priority Data
Mar. 28, 2012 (TW) 101110728

(51) Int. Cl. G02F 1/1343

(52) U.S. Cl. CPC G02F 1/134309
USPC 349/139

(57) ABSTRACT

A liquid crystal display device is disclosed, which includes a first substrate, a second substrate and a liquid crystal layer containing Chiral dopants. The second substrate includes a blue sub-pixel region and a blue sub-pixel electrode unit disposed in the blue sub-pixel region. The numerical ranges of the characteristic parameters of the liquid crystal layer are 0.33≦Δnd≦0.62 and 0.2≦d/p≦0.36. The ratio of the area of the hollowed regions in the blue sub-pixel region, to the area of the blue sub-pixel region, is larger than or equal to 54%.

### CROSS REFERENCE TO RELATED APPLICATIONS

This application claims priority of Taiwan Patent Application No. 101110728, filed on Mar. 28, 2012, the entirety of which is incorporated by reference herein.

### BACKGROUND OF THE INVENTION

1. Field of the Invention

The present invention relates to a liquid crystal display device, and in particular relates to liquid crystal display device having red, green, and blue sub-electrodes.

2. Description of the Related Art

In recent years, flat panel displays (FPDs) have developed rapidly and gradually replaced traditional cathode radiation tube displays. Today, major flat panel displays include: organic light-emitting diodes displays (OLEDs), plasma display panels (PDPs), liquid crystal displays (LCDs), and field emission displays (FEDs). Each of these FPDs is composed of many pixels, each of which is a key component of the FPD.

An LCD is one kind of FPD that has a high resolution and small size, and low power consumption. Fabrication productivity and performance of an LCD is higher than other FPDs. Also, when compared to other FPDs, an LCD is lower priced. As a result, the size of the LCD market has increased.

For a conventional LCD, each pixel needs a drive voltage to provide an electric field for liquid crystal molecules reorientation in the pixel and such that the LCD can display a frame with different brightness and contrast for different pixels. Because of the single drive voltage applied to each pixel in the conventional LCD, gray level inverses for large viewing angles and degrades display performance. Furthermore, for conventional twisted nematic liquid crystal displays (TN LCDs), there are problematic gray level inversions caused by over-changing of the viewing angle. In general, for LCDs, a higher gray level in a pixel indicates a higher level of brightness in the pixel. For example, a pixel with a gray level of 0 displays black, while one with a gray level of 255 displays white. However, when viewing the TN LCD from a large viewing angle, pixels of the lower gray level display higher brightness than those of the higher gray level. Hence, a user would view the TN LCD with black-white inversion, also known as gray level inversions.

### BRIEF SUMMARY OF THE INVENTION

In light of the foregoing, one of the objectives of the present invention is to provide a liquid crystal display device with improved gray level inversion.

In one of the embodiments, a liquid crystal display device includes a first substrate, a second substrate and a liquid crystal layer containing Chiral dopants. The second substrate includes a red sub-pixel region, a green sub-pixel region, a blue sub-pixel region, a red sub-pixel electrode unit, a green sub-pixel electrode unit, and a blue sub-pixel electrode unit, wherein the red, the green, and the blue sub-pixel electrode units are respectively disposed in the red, the green, and the blue sub-pixel regions. The liquid crystal layer is disposed between the first and the second substrates, and numerical ranges of the characteristic parameters of the liquid crystal layer are 0.33≦Δnd≦0.62 and 0.2≦d/p≦0.36.

In one embodiment, the ratio of the area of the portions in the blue sub-pixel region where the blue sub-pixel electrode unit are not disposed, to the area of the blue sub-pixel region is larger than or equal to 54%, achieving the objectives of the present invention.

In one embodiment, the ratios of the area of the portions in the red, the green, and the blue sub-pixel regions where the red, the green, and the blue sub-pixel electrode units are not disposed, to the area of the red, the green, and the blue sub-pixel regions, are larger than or equal to 54%, achieving the objectives of the present invention.

In still one the other embodiment, the ratios of the area of the portions in the red, and the green sub-pixel regions where the red, and the green sub-pixel electrode units are not disposed, to the area of the red, and the green sub-pixel regions, are larger than or equal to 54%, and the ratio of the area of the portions in the blue sub-pixel region where the blue sub-pixel electrode unit are not disposed, to the area of the blue sub-pixel region is larger than or equal to 70%, achieving the objectives of the present invention.

In one embodiment, the red, the green, and the blue sub-pixel electrode units respectively includes a plurality of main electrodes and a plurality of branch electrodes. The plurality of main electrodes extends outwardly from substantially a center of the red, the green, and the blue sub-pixel electrode units to define a plurality of branch electrode regions. The plurality of branch electrodes extends from the main electrodes to the branch electrode regions to form desired electrode patterns, wherein the branch electrode regions include electrode patterns of two different duty ratios.

In one embodiment, the branch electrode regions of the red, the green, and the blue sub-pixel electrode units include electrode patterns having different electrode patterns.

In one embodiment, the red, the green, and the blue sub-pixel electrode units include electrode patterns having different electrode patterns.

Though the electrode patterns are formed in the sub-pixel regions, the electric field strength applied to the liquid crystal molecules of the liquid crystal layer is sufficient to generate two different electric field intensities in a single sub-pixel region, so as to improve the gray-scale inversion phenomenon.

### BRIEF DESCRIPTION OF THE DRAWINGS

The present invention is more fully understood by reading the subsequent detailed description and examples with references made to the accompanying drawings, wherein:

FIG. 1 shows an explosive view of a display device in accordance with various embodiments of the present invention;

FIG. 2a shows a schematic view of a red, a green, and a blue sub-electrode in accordance with one of the embodiments of the present invention;

FIG. 2b shows a schematic view of a red, a green, and a blue sub-electrode in accordance with the other embodiments of the present invention;

FIG. 2c shows a schematic view of a red, a green, and a blue sub-electrode in accordance with still the other embodiments of the present invention;

FIG. 3 shows a voltage-normalized transmittance relational graph of the electrodes showing in FIG. 2b in an oblique-view direction;

FIG. 4 shows a schematic view of a red, a green, and a blue sub-electrode in accordance with still the other embodiments of the present invention;

FIG. 5 shows a voltage-normalized transmittance relational graph of the electrodes showing in FIG. 4 in an oblique-view direction;

FIGS. 6a-6c show voltage-normalized transmittance relational graphs of the sub-pixel electrode units having different duty ratios in an oblique-view direction;

FIGS. 6d-6f show voltage-normalized transmittance relational graphs of the sub-pixel electrode units having different duty ratios in an oblique-view direction;

FIGS. 7a-7d show different arrangement patterns of sub-pixel electrode units of various embodiments;

FIGS. 8a-8d show different arrangement patterns of sub-pixel electrode units of various embodiments;

FIGS. 9a-9b show different arrangement patterns of sub-pixel electrode units of various embodiments;

FIGS. 10a-10b show different arrangement patterns of sub-pixel electrode units of various embodiments;

FIGS. 11a-11c show different arrangement patterns of sub-pixel electrode units of various embodiments; and

FIG. 12 shows different arrangement patterns of sub-pixel electrode units of the other embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

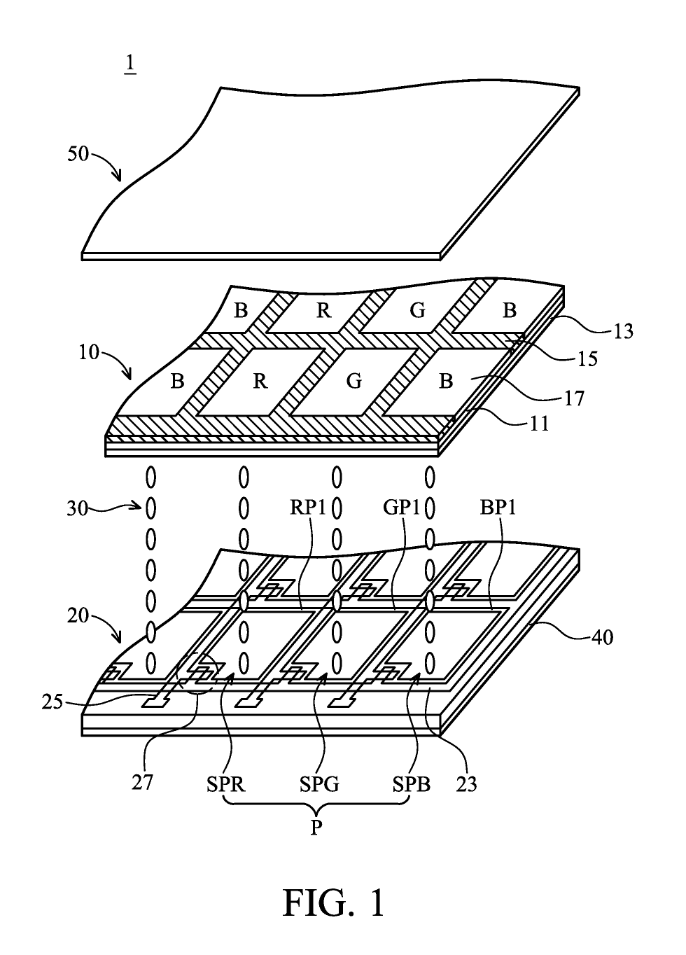

Refer to FIG. 1. A liquid crystal display (LCD) device 1 in various embodiments of the present invention includes: a first substrate 10, a second substrate 20, a liquid crystal layer 30, a lower polarizing film 40 and an upper polarizing film 50.

The first substrate 10 includes a color filter 11, a transparent common electrode 13 and a black matrix 15. The color filter 11 includes a plurality of sub-color filters 17 including red filters R, green filters G and blue filters B. The common electrode 13 is located adjacent to the liquid crystal layer 30 (detailed features of which will be described later) to drive the liquid crystal molecules in the liquid crystal layer 30. The black matrix 15 is located between each two of the sub-color filters 17 to block light rays from the back thereof.

The second substrate 20 includes a plurality of gate lines 23, a plurality of data lines 25, a plurality of thin-film transistors (TFTs) 27 and a plurality of pixel units P. The gate lines 23 and the data lines 25 are arranged in a horizontal direction and a vertical direction, respectively, and the TFTs 27 are formed at locations where the gate lines 23 and the data lines 25 intersect, respectively. Each of the pixel units P includes a plurality of sub-pixel regions SPR, SPG and SPB and a plurality of sub-pixel electrode units RP1, GP1, and BP1. Each of the pixel regions has at least one electrode therein. The sub-pixel regions SPR, SPG and SPB are located in areas enclosed by the gate lines 23 and the data lines 25, respectively, and are arranged sequentially in a direction. The sub-pixel electrode units RP1 are disposed in the sub-pixel regions SPR and face the red filters R. The sub-pixel electrode units GP1 are disposed in the sub-pixel regions SPG and face the green filters G. The sub-pixel electrode units BP1 are disposed in the sub-pixel regions SPB and face the blue filters B.

In the following description, the sub-pixel electrode unit RP1, the sub-pixel electrode unit GP1 and the sub-pixel electrode unit BP1 are referred to as a red sub-pixel electrode unit, green sub-pixel electrode unit and blue sub-pixel electrode unit, respectively, and the sub-pixel regions SPR, the sub-pixel regions SPG and the sub-pixel regions SPB are referred to as red sub-pixel regions, green sub-pixel regions and blue sub-pixel regions, respectively. A sub-pixel region includes at least one sub-pixel electrode unit. In the following description, a case in which a sub-pixel region includes three identical sub-pixel electrode units will be illustrated as an example; however, in practical applications, the present invention is not limited to this. For example, a pixel region may include only one sub-pixel electrode unit or a sub-pixel region may include a plurality of identical sub-pixel electrode units or a pixel region may include a plurality of different sub-pixel electrode units.

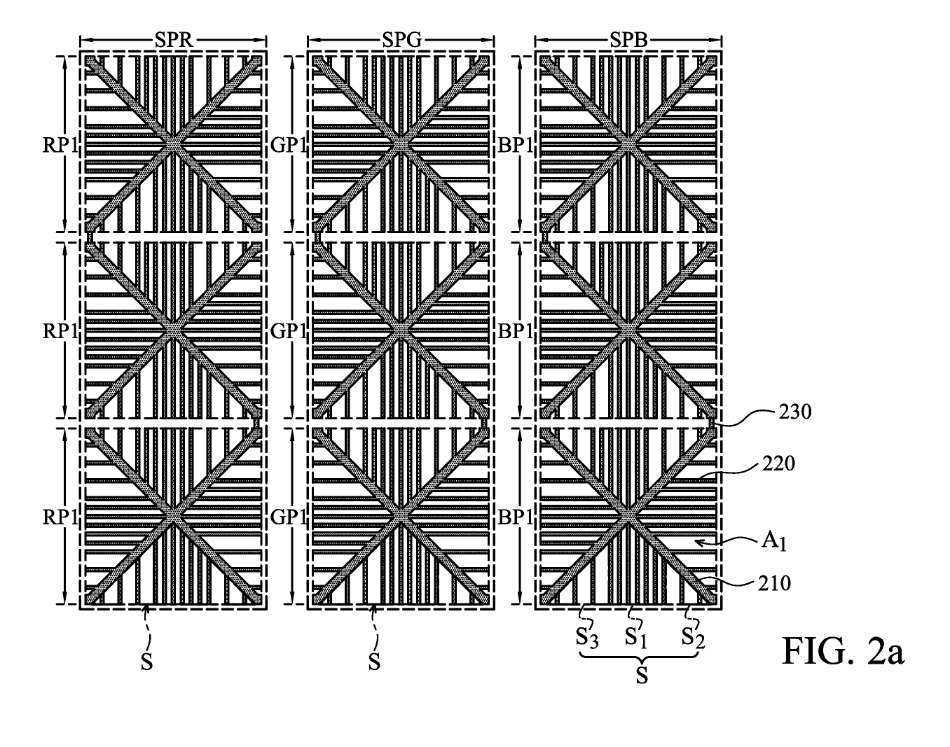

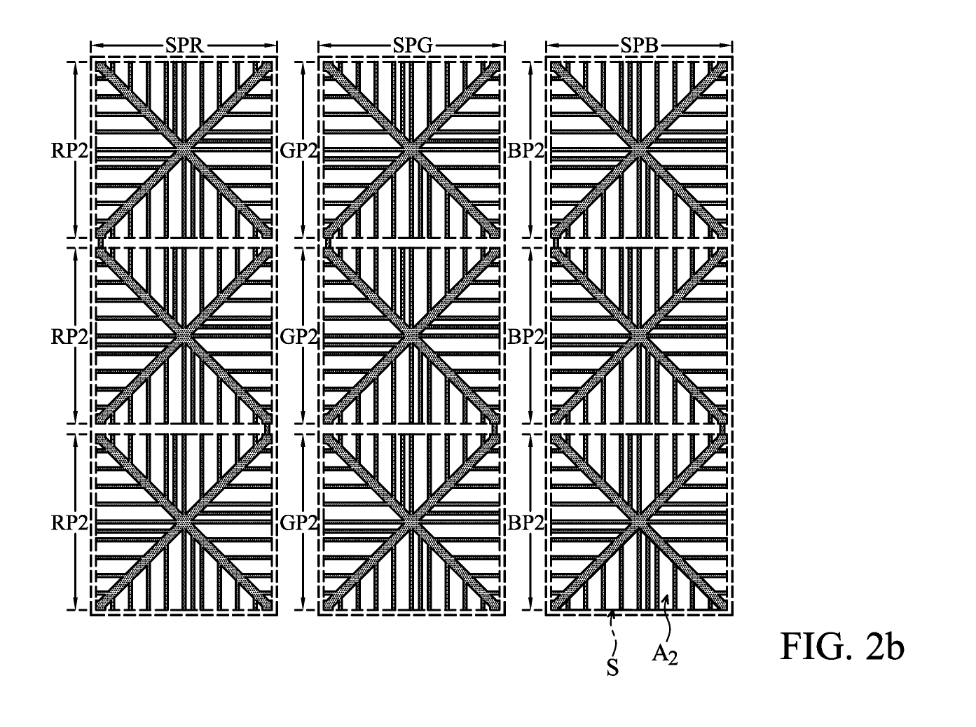

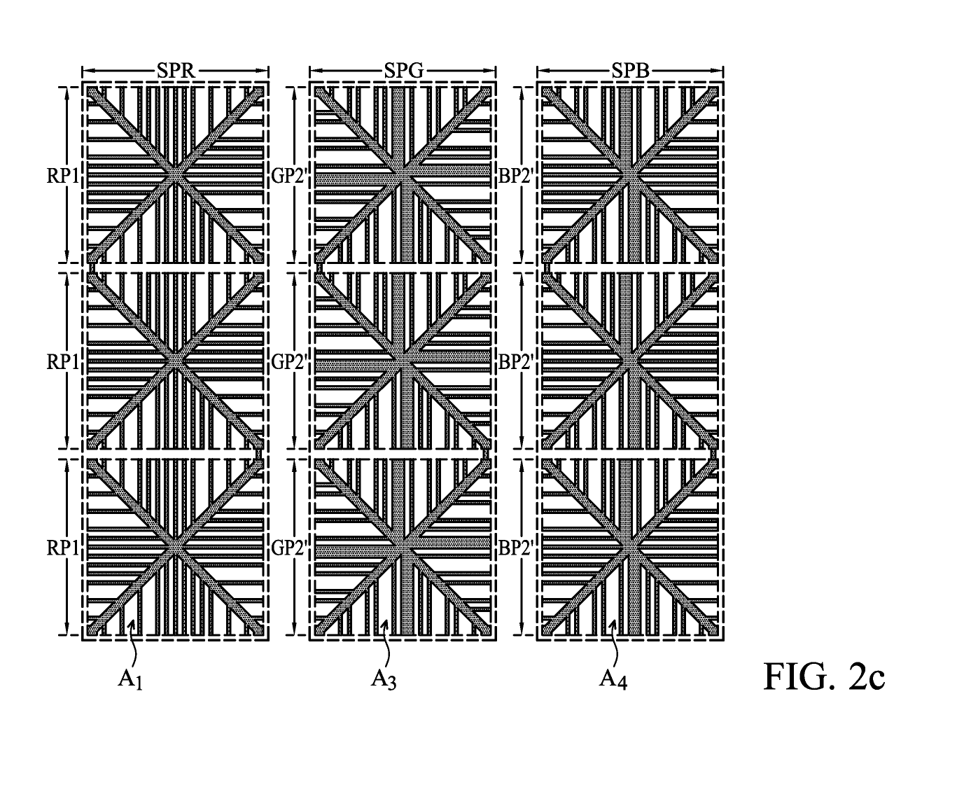

Referring to FIG. 2a, the features of the red sub-pixel electrode unit RP1, the green sub-pixel electrode unit GP1 and the blue sub-pixel electrode unit BP1 will be described next. In an embodiment, each of the blue sub-pixel regions SPB includes three identical blue sub-pixel electrode units BP1 and a plurality of connection electrodes 230. The blue sub-pixel electrode units BP1 are connected with each other via the connection electrodes 230, and each of the blue sub-pixel electrode units BP1 includes four main electrodes 210 and a plurality of branch electrodes 220. The four main electrodes 210 extend outwardly from substantially a center of the blue sub-pixel electrode unit BP1 to define four substantially triangular branch electrode regions S in the single blue sub-pixel electrode unit BP1. The branch electrodes 220 extend from the four main electrodes 210 to the branch electrode regions S, and form desired electrode patterns in the branch electrode regions S. The area of the portions in the blue sub-pixel region SPB where the blue sub-pixel electrode units BP1 and the connection electrodes 230 are not disposed is a hollowed region A₁. In this embodiment, the area of the hollowed region A₁ accounts for about 61% of the area of the blue sub-pixel region SPB.

Note that, in this embodiment, a single branch electrode region S includes two kinds of electrode patterns having different duty ratios. Here, the duty ratio refers to a ratio of the area of the electrodes disposed in a single region, to the area of the region. For example, if the duty ratio of the electrode pattern in a sub-region S₁ is larger than the duty ratios of the electrode patterns in sub-regions S₂ and S₃, then it means that a ratio of the area of the electrodes disposed in the sub-region S₁ to the area of the sub-region S₁ is larger than ratios of the areas of the electrodes disposed in the respective sub-regions S₂ and S₃ to the respective areas of the sub-regions S₂ and S₃. In this embodiment, the electrode patterns of the sub-regions S₂ and S₃ have the same duty ratio, the electrode pattern of the sub-region S₁ has a duty ratio larger than that of the electrode patterns of the sub-regions S₂ and S₃, and the sub-region S₁ is disposed between the sub-regions S₂ and S₃. Therefore, after the blue sub-pixel electrode unit BP1 is energized, the electric field strength applied to the liquid crystal molecules of the liquid crystal layer is sufficient to generate two different electric field intensities in each of the branch electrode regions S, with the electric field intensity in the sub-region S₁ being larger than that in the sub-regions S₂ and S₃. Thereby, two different voltage-transmittance curves (V-T curves) are generated in the blue sub-pixel region SPB to improve the gray-scale inversion phenomenon. In addition, in this embodiment, the area of the sub-region S₁ accounts for 50% of the area of the single branch electrode region S. However, in other embodiments, the area of the sub-region S₁ to the area of the single branch electrode region S may be other ratios. In this embodiment, the features of the red sub-pixel electrode units RP1 and the green sub-pixel electrode units GP1 are the same as those of the blue sub-pixel electrode units BP1, thus, they will not be further detailed for brevity.

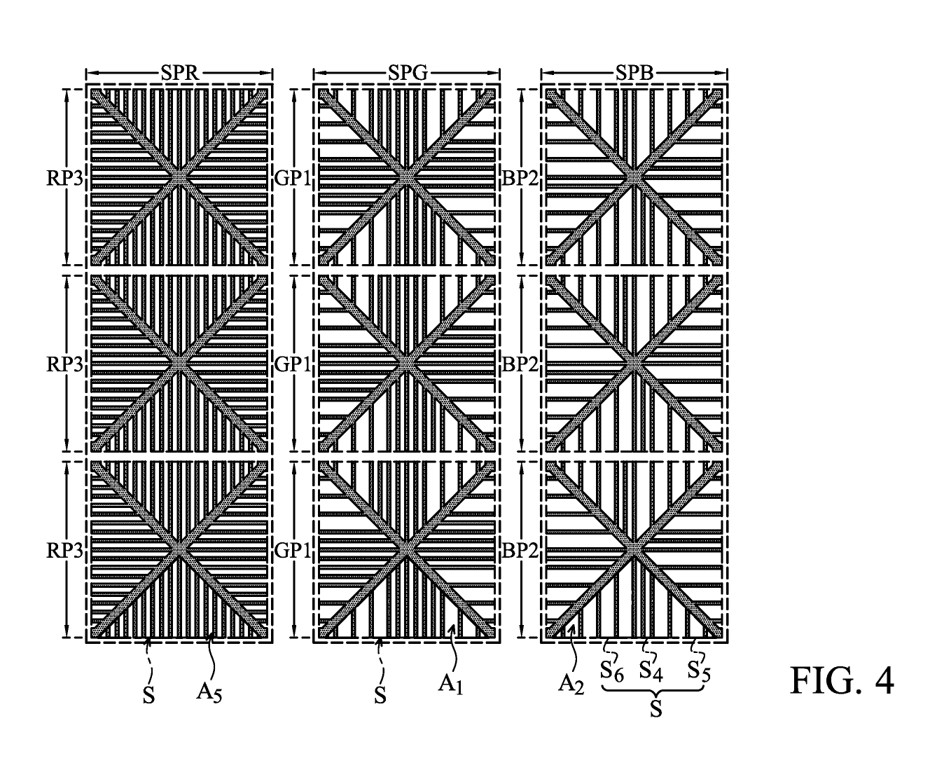

Referring to FIG. 2b, a schematic view illustrating red sub-pixel electrode units RP2, green sub-pixel electrode units GP2 and blue sub-pixel electrode unit BP2 according to another embodiment of the present invention is shown. In FIG. 2b, components identical to those in FIG. 2a will be represented by the same reference numbers, and the features thereof will not be further described. Each of the blue sub-pixel electrode units BP2 includes four branch electrode regions S, and the electrode patterns in the branch electrode regions S of the blue sub-pixel electrode unit BP2 are different from those in the branch electrode regions S of the blue sub-pixel electrode unit BP1 (FIG. 2a). Specifically, the area of hollowed regions A₂ in the blue sub-pixel region SPB accounts for about 67% of the area of the blue sub-pixel region SPB, and the detailed features of the electrode pattern in each of the branch electrode regions S are described below with additional reference to FIG. 4.

However, it is worth noting that, although the red sub-pixel electrode units RP1, the green sub-pixel electrode units GP1 and the blue sub-pixel electrode units BP1 have the same electrode patterns in the branch electrode regions S and the red sub-pixel electrode units RP2, the green sub-pixel electrode units GP2 and the blue sub-pixel electrode units BP2 have the same electrode patterns in the branch electrode regions S in the embodiments shown in FIG. 2a and FIG. 2b, the red sub-pixel electrode units, the green sub-pixel electrode units and the blue sub-pixel electrode units may include different electrode patterns as desired and the branch electrode regions of the red sub-pixel electrode units, the green sub-pixel electrode units and the blue sub-pixel electrode units may also include different electrode patterns.

For example, referring to FIG. 2c, there is shown another embodiment of the red sub-pixel electrode units RP1, the green sub-pixel electrode units GP2′ and the blue sub-pixel electrode units BP2′. In FIG. 2c, components identical to those in FIG. 2a will be represented by the same reference numbers, and the features thereof will not be further described. In this embodiment, the red sub-pixel electrode units RP1, the green sub-pixel electrode units GP2′ and the blue sub-pixel electrode units BP2′ include different electrode patterns, and branch electrode regions S of each of the blue sub-pixel electrode units BP2′ include different electrode patterns. In detail, the electrode patterns located in four branch electrode regions S of each of the green sub-pixel electrode units GP2′ are different from those located in four branch electrode regions S of each of the red sub-pixel electrode units RP1, and the electrode patterns in the upper and the lower branch electrode regions S of each of the blue sub-pixel electrode units BP2′ are different from the electrode patterns in the four branch electrode regions S of each of the red sub-pixel electrode units RP1. However, it shall be noted that, although the electrode patterns of the red sub-pixel electrode units RP1, the green sub-pixel electrode units GP2′ and the blue sub-pixel electrode units BP2′ are different from each other, the areas of the hollowed regions A₁, A3, A4 of the red, the green and the blue sub-pixel regions SPR, SPG and SPB all account for about 61% of the areas of the red, the green and the blue sub-pixel regions SPR, SPG and SPB, respectively. In brief, the electrode patterns of the red, the green and the blue sub-pixel electrode unit may be the same or different.

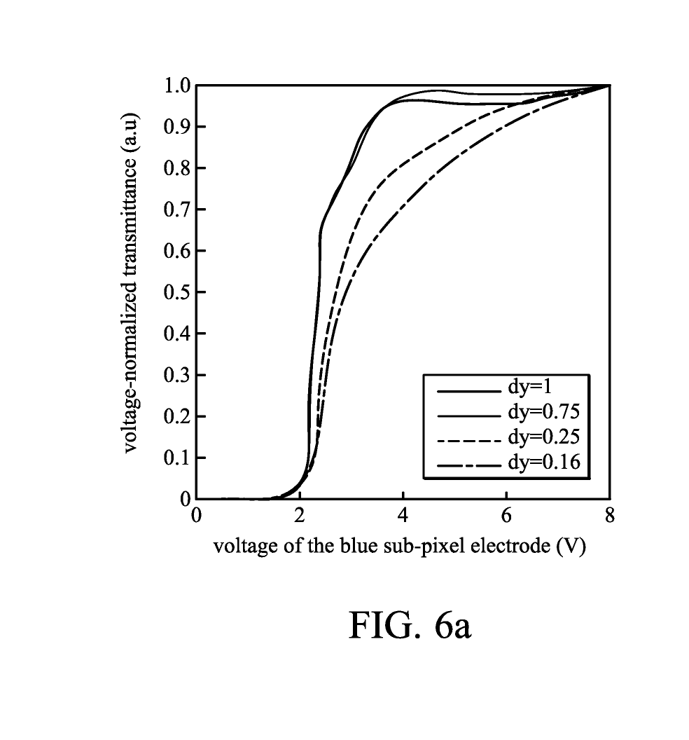

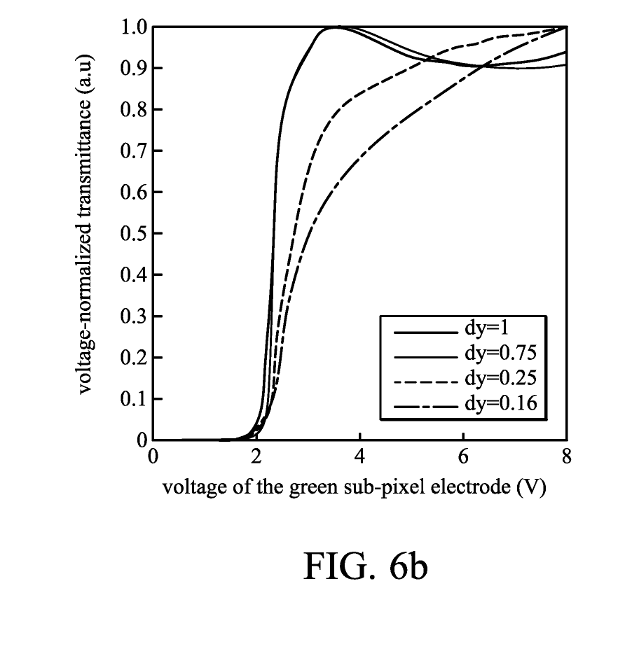

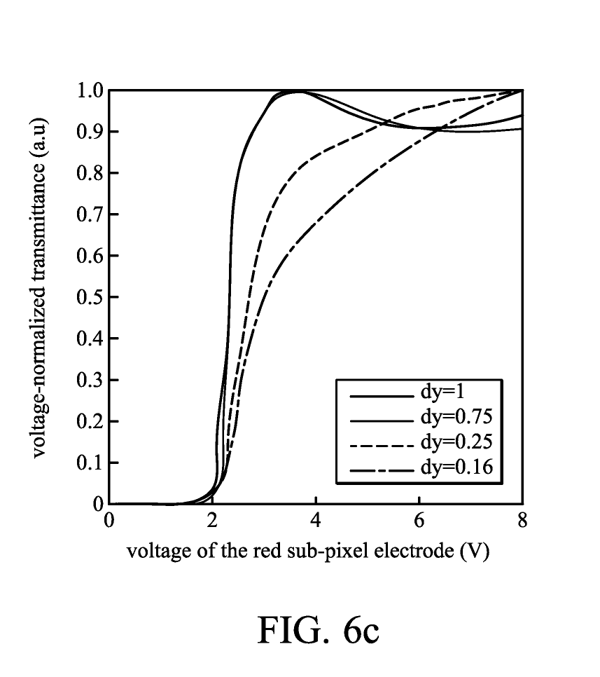

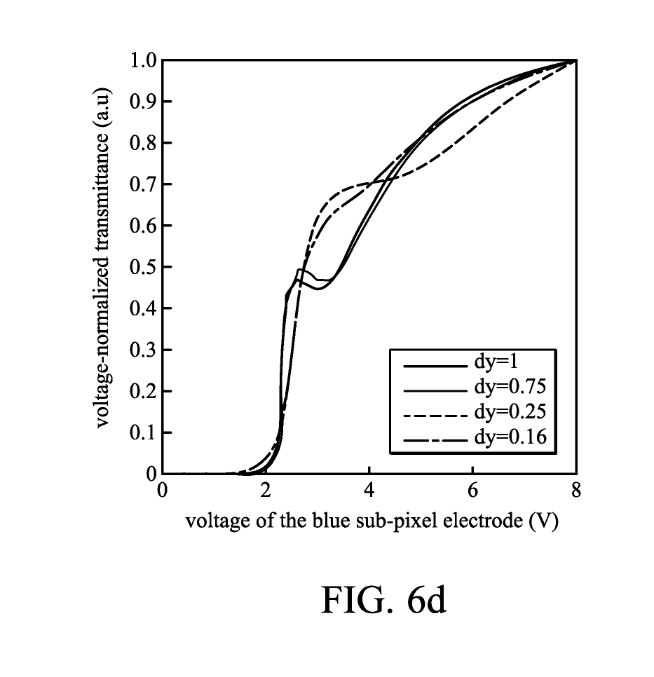

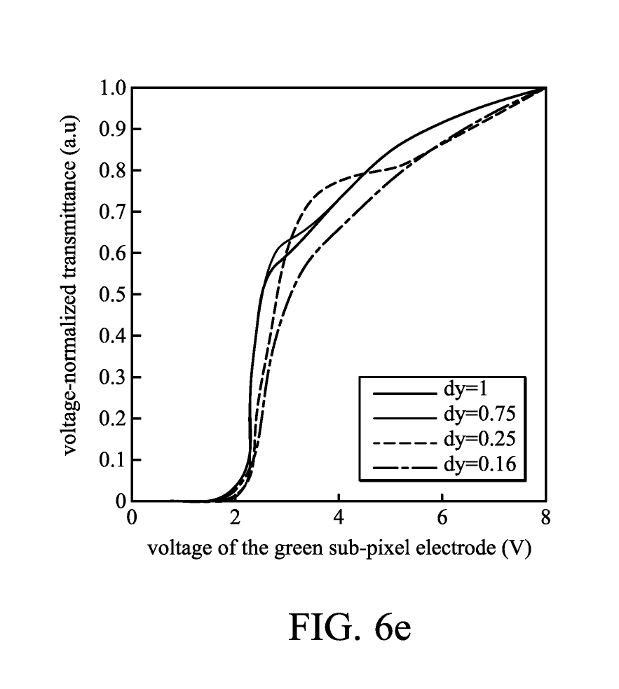

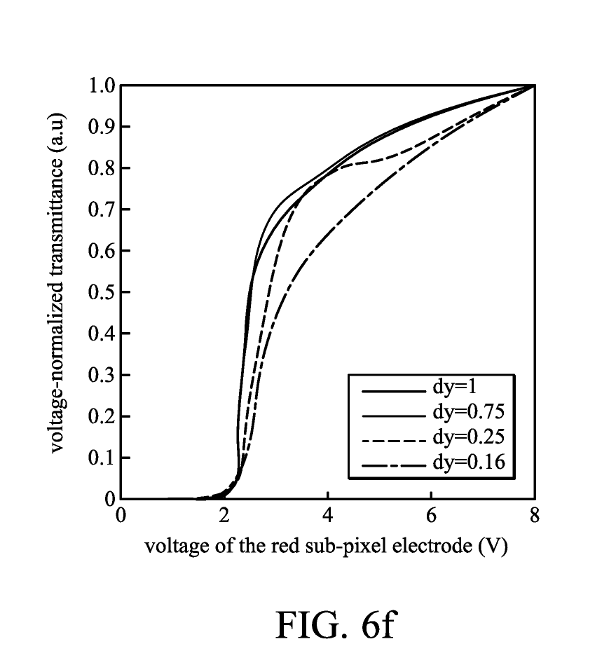

In addition, the electrode patterns may also be adjusted as desired with respect to the thickness of the main electrodes or the thickness and the shape of the branch electrodes. In some embodiments, the area of the hollowed regions will vary with different electrode patterns. However, the ratio of the area of the hollowed regions in the blue sub-pixel region SPB to the area of the blue sub-pixel region SPB needs to be larger than or equal to 54% and preferably larger than or equal to 70%, for reasons which will be detailed later with reference to FIG. 6a to FIG. 6f.

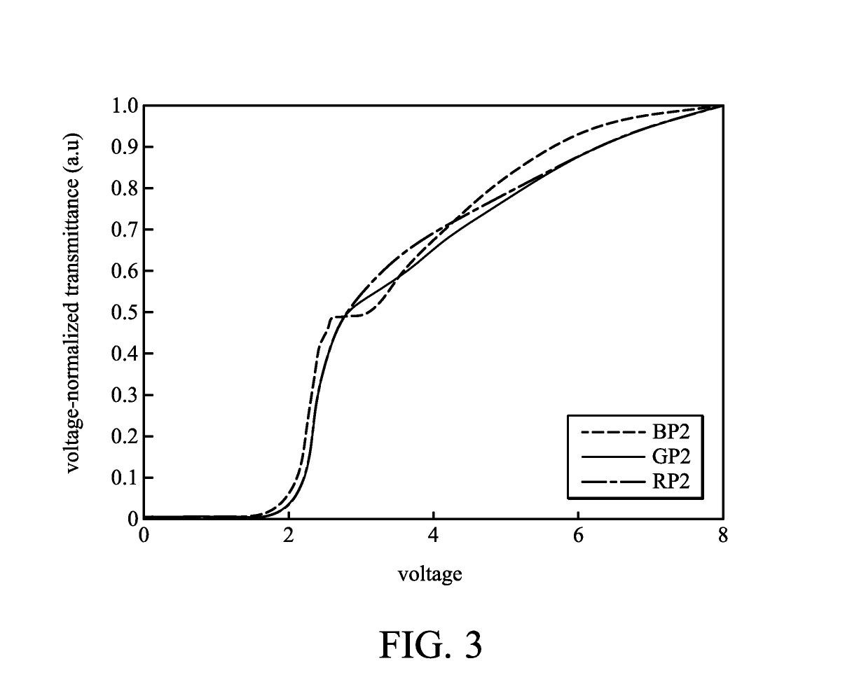

Refer to FIG. 1 again. The liquid crystal layer 30 is disposed between the first substrate 10 and the second substrate 20. The liquid crystal layer 30 is a negative type liquid crystal material (i.e., the dielectric anisotropy is a negative value (Δ∈<0)) and has a Chiral dopant doped therein. In an embodiment, the liquid crystal layer 30 doped with the Chiral dopant has a characteristic parameter Δnd of 0.538 and a characteristic parameter d/p of 0.278, where Δn represents the birefringence of the liquid crystal material, d represents a thickness of the liquid crystal layer, and p represents the pitch of the Chiral molecules (Chiral pitch). The upper polarizing film 50 is disposed at a side of the first substrate 10 that is away from the liquid crystal layer 30, and the lower polarizing film 40 is disposed at a side of the second substrate 20 that is away from the liquid crystal layer 30. FIG. 3 illustrates a voltage-normalized transmittance relational graph of the electrode patterns of the red, the green and the blue sub-pixel electrode units RP2, GP2, and BP2 in FIG. 2b in an oblique-view direction (which is parallel with the direction of the gate lines and includes an angle of 60° with a front-view direction (i.e., the azimuth angle is 0° and the polar angle is 60°)). As shown in FIG. 3, slopes of the voltage-normalized transmittance curves of the red, the green and the blue sub-pixel electrode units RP2, GP2, and BP2 all positively vary; i.e., the gray-scale inversion phenomenon is improved.

Refer to FIG. 6a to FIG. 6f. FIG. 6a to FIG. 6c respectively illustrate a voltage-normalized transmittance relational graph of the red, the green and the blue sub-pixels in the oblique-view direction when the liquid crystal layer doped with the Chiral dopant has a characteristic parameter Δnd of 0.33 and a characteristic parameter d/p of 0.36 and the branch electrode regions of the red, the green and the blue sub-pixel electrode units have a single duty ratio (i.e., duty ratios in the branch electrode regions are all the same as each other). FIG. 6d to FIG. 6f illustrate a voltage-normalized transmittance relational graph of the red, the green and the blue sub-pixels in the oblique-view direction when the liquid crystal layer doped with the Chiral dopant has a characteristic parameter Δnd of 0.33 and a characteristic parameter d/p of 0.222 and the branch electrode regions of the red, the green and the blue sub-pixel electrode units have a single duty ratio. In FIG. 6a to FIG. 6f, the duty ratio dy equal to 1 represents that a single branch electrode region is full of electrodes, the duty ratio dy equal to 0.25 represents that the ratio of the area of the electrodes in a single branch electrode region, to the area of the branch electrode region is 0.25, and so on.

As is seen from FIG. 6a to FIG. 6f together, when the duty ratio dy in a single branch electrode region decreases (i.e., regions where electrodes are not disposed increases) at the same drive voltage, the gray-scale inversion phenomenon of the sub-pixel electrodes is improved more significantly although the front-view transmittance of the sub-pixel electrodes is slightly reduced. On the other hand, as is seen from FIG. 6d, FIG. 6e and FIG. 6f, the blue sub-pixel electrode units (FIG. 6d) are more liable to generate the gray-scale inversion phenomenon than the green sub-pixel electrode units (FIG. 6e) and the red sub-pixel electrode units (FIG. 6f). In this embodiment, when the red, the green and the blue sub-pixel electrode units are all of the duty ratio dy=0.25, the front-view angle transmittance is slightly reduced although the slopes of the voltage-normalized transmittance curves of the red and the green sub-pixels in the oblique-view direction both positively vary and relatively smooth curves can be obtained. Therefore, to ensure that both the front-view transmittance and the image quality in the oblique-view direction are satisfied, the red and the green sub-pixel electrode units are preferably of a duty ratio dy smaller than or equal to 0.5; i.e., the area of the hollowed regions in the red and the green sub-pixel regions is larger than or equal to 54%. More preferably, the red and the green sub-pixel electrode units are of a duty ratio dy smaller than or equal to 0.25; i.e., the area of the hollowed regions of the red and the green sub-pixels is larger than or equal to 70%.

Another embodiment is provided based on the features of the embodiments shown in FIG. 2a and FIG. 2b and the aforesaid observation results. Referring to FIG. 4, a schematic view illustrating the red, the green and the blue sub-pixel electrode units RP3, GP1, and BP2 according to another embodiment of the present invention is shown. In FIG. 4, components identical to those in FIG. 2a and FIG. 2b will be represented by the same reference numbers, and the features thereof will not be further described. In this embodiment, as compared to the red, the green and the blue sub-pixel electrode units RP1, GP1, and BP1 in FIG. 2a, the area of the portions in the blue sub-pixel region SPB where the electrodes are not disposed is further increased, but the area of the portions in the red sub-pixel region SPR where the electrodes are not disposed is decreased. That is, the red, the green and the blue sub-pixel electrode units RP3, GP1, and BP2 all have different electrode patterns.

In detail, refer to FIG. 2a and FIG. 4 together. A single branch electrode region S of each of the blue sub-pixel electrode units BP2 includes three sub-regions S4, S5 and S6. The area of the sub-region S4 only accounts for 20% of the area of the single branch electrode region S, and the duty ratio of the electrode pattern in the sub-region S₄ is equal to the duty ratio of the electrode pattern in the sub-region S₁, and the area of the sub-regions S₅ and S₆ only accounts for 80% of the area of the single branch electrode region S, and the duty ratios of the electrode patterns in the sub-regions S₅ and S₆ are equal to the duty ratios of the electrode patterns in the sub-regions S₂ and S₃. That is, the area of the hollowed regions A₂ in the blue sub-pixel region SPB is increased. The branch electrode regions S of each of the red sub-pixel electrode units RP3 includes electrode patterns of a single duty ratio which is equal to the duty ratio of the electrode pattern in the sub-region S₁, and this represents that the area of the hollowed regions A₅ in the red sub-pixel region SPR is decreased. In this embodiment, the area of the hollowed regions A₂ in the blue sub-pixel region SPB accounts for 67% of the area of the blue sub-pixel region SPB, the area of the hollowed regions A₁ in the green sub-pixel region SPG accounts for 61% of the area of the green sub-pixel region SPG, and the area of the hollowed regions A₅ in the red sub-pixel region SPR accounts for 54% of the area of the red sub-pixel region SPR.

The areas of the hollowed regions A₁, A₂, and A₅ shall not be limited to what is described in the aforesaid embodiments, and may vary with the electrode patterns. For example, the areas of the hollowed regions A₁, A₂, and A₅ vary with factors such as the thickness of the main electrodes as well as the thickness, the shape and arrangement of the branch electrodes. However, it shall be noted that, the ratio of the area of the hollowed regions A₂ in the blue sub-pixel region SPB to the area of the blue sub-pixel region SPB needs to be larger than or equal to 54% and is preferably larger than or equal to 70%, for reasons which will be detailed later with reference to FIG. 6a to FIG. 6f.

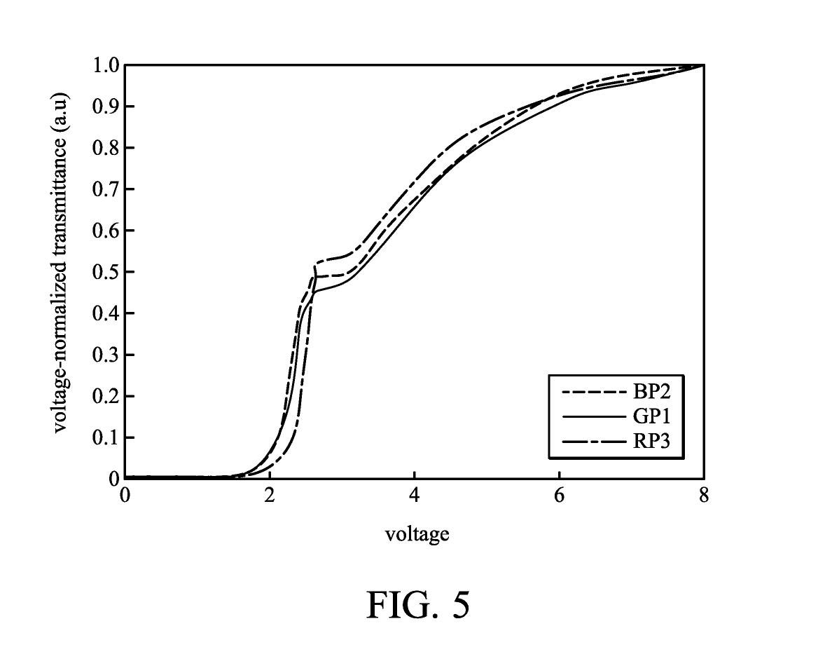

Referring to FIG. 5, a voltage-normalized transmittance relational graph of the red, the green and the blue sub-pixels in FIG. 4 in the oblique-view direction is shown. As shown in FIG. 5, as the voltage increases, the transmittances of the red, the green and the blue sub-pixel electrode units RP3, GP1, and BP2 in the oblique-view direction increases gradually and the curves positively vary, and this represents that the gray-scale inversion phenomenon generated by the red, the green and the blue sub-pixel electrode units RP3, GP1, and BP2 at different drive voltages is improved. On the other hand, as can be seen from comparison between the voltage-normalized transmittance relational graphs in FIG. 5 and FIG. 3, the red sub-pixel electrode units RP2 of FIG. 2b have larger hollowed regions as compared to the red sub-pixel electrode units RP3 of FIG. 4. Therefore, the curve of the red sub-pixel electrode units RP2 is relatively smooth; i.e., the electrode design of the red sub-pixel electrode unit RP2 achieves a better effect for improving the gray-scale inversion phenomenon. The electrode design of the red sub-pixel electrode units RP3 can also improve the gray-scale inversion phenomenon. Although the improving capability of the red sub-pixel electrode units RP3 is weaker than that of the red sub-pixel electrode units RP1, the transmittance from a front view direction can be increased.

It shall be noted that, although the branch electrodes of the green and the blue sub-pixel electrode units GP1, BP2 in FIG. 4 include electrode patterns of two different duty ratios, branch electrode patterns of a single or more duty ratios may also be used in combination with other sub-pixel electrode patterns as desired in other embodiments. As can be seen from the above description, the objective of the present invention can be achieved as long as the area of the hollowed regions in the blue sub-pixel electrode units is larger than the area of the hollowed regions in the red or the green sub-pixel electrode units. For example, in an embodiment, the branch electrode regions of the red, the green and the blue sub-pixel electrode units all include electrode patterns of a single duty ratio; however, the objective of the present invention can be achieved as long as the duty ratio of the branch electrode regions of the blue sub-pixel electrode units is smaller than that of the branch electrode regions of the green sub-pixel electrode units (the area of the hollowed regions in the blue sub-pixel region is larger than the area of the hollowed regions in the green sub-pixel region) or the duty ratio of the branch electrode regions of the blue sub-pixel electrode units is smaller than that of the branch electrode regions of the red sub-pixel electrode units (the area of the hollowed regions in the blue sub-pixel region is larger than the area of the hollowed regions in the red sub-pixel region). That is, the objective of the present invention can be achieved as long as the electrode pattern of one sub-pixel electrode unit is different from the electrode patterns of the other two sub-pixel electrode units.

Refer to FIG. 6a to FIG. 6c again. Ratio variations of the hollowed regions in the pixel regions and the relationship between the voltage and the normalized transmittance in the oblique-view direction when the liquid crystal layer doped with the Chiral dopant has a characteristic parameter Δnd of 0.33 and a characteristic parameter d/p of 0.36 will be described herein.

In FIG. 6a, when the duty ratio dy of the blue sub-pixel electrode units is equal to 0.75 (in this case, the area of the hollowed regions in the blue sub-pixel region is about 37% of the blue sub-pixel region), the slope of the curve thereof varies more flatly than that of the curve when the duty ratio dy of the blue sub-pixel electrode units is equal to 1. When the duty ratio dy of the blue sub-pixel electrode units is equal to 0.25 (in this case, the area of the hollowed regions in the blue sub-pixel region is about 70% of the blue sub-pixel region), the slope of the curve thereof consistently varies in a positive manner as compared to the slope variations of the curve when the duty ratio dy of the blue sub-pixel electrode units is equal to 1; i.e., no negative slope of the curve is generated, which represents that the capability of improving the gray-scale inversion phenomenon is increased significantly. When the duty ratio dy of the blue sub-pixel electrode units is equal to 0.16 (in this case, the area of the hollowed regions in the blue sub-pixel region is about 76% of the blue sub-pixel region), the curve thereof positively varies and is also more smooth. That is, as the duty ratio of the electrodes decreases (i.e., the area of the hollowed regions increases), the capability of improving the gray-scale inversion phenomenon increases gradually and the image quality in the oblique-view direction can be further improved. In addition, when the characteristic parameter Δnd is 0.62, the electrode pattern of the blue sub-pixels also has the tendency that the capability of improving the gray-scale inversion phenomenon increases gradually as the area of the hollowed regions increases.

However, as the duty ratio of the electrodes decreases (i.e., the area of the hollowed regions increases), the front-view transmittance decreases at the same voltage. To ensure that both the front-view transmittance and the image quality in the oblique-view direction are satisfied, the duty ratio dy of the blue sub-pixel electrode units is preferably smaller than or equal to 0.5 (i.e., the area of the hollowed regions in the blue sub-pixel region is larger than or equal to 54% of the blue sub-pixel region) in a preferred embodiment, and more preferably, the area of the hollowed regions in the blue sub-pixel region is larger than or equal to 70% of the blue sub-pixel region.

In FIG. 6b, when the duty ratio dy of the green sub-pixel electrode units is equal to 0.75 (in this case, the area of the hollowed regions in the green sub-pixel region is about 37% of the green sub-pixel region), the slope of the curve thereof varies more flatly than that of the curve when the duty ratio dy of the green sub-pixel electrode units is equal to 1. When the duty ratio dy of the green sub-pixel electrode units is equal to 0.25 (in this case, the area of the hollowed regions in the green sub-pixel region is about 70% of the green sub-pixel region), the slope of the curve thereof consistently varies in a positive manner; that is, no negative slope of the curve is generated, which represents that the capability of improving the gray-scale inversion phenomenon is increased significantly. Moreover, when the duty ratio dy of the green sub-pixel electrode units is equal to 0.16 (in this case, the area of the hollowed regions in the green sub-pixel region is about 76% of the green sub-pixel region), the slope of the curve thereof positively varies and is also more smooth, and the image quality in the oblique-view direction is further improved. That is, as the duty ratio of the electrodes decreases (i.e., the area of the hollowed regions increases), the capability of improving the gray-scale inversion phenomenon increases gradually. In addition, when the characteristic parameter Δnd is 0.62, the electrode pattern of the green sub-pixels also has the tendency that the capability of improving the gray-scale inversion phenomenon increases gradually as the area of the hollowed regions increases. However, to ensure that both the front-view transmittance and the image quality in the oblique-view direction are satisfied, the duty ratio dy of the green sub-pixel electrode units is preferably smaller than or equal to 0.5 (i.e., the area of the hollowed regions in the green sub-pixel region is larger than or equal to 54% of the green sub-pixel region) in a preferred embodiment, and more preferably, the area of the hollowed regions in the green sub-pixel region is larger than or equal to 70% of the green sub-pixel region.

As shown in FIG. 6c, when the duty ratio dy of the red sub-pixel electrode units is equal to 0.75 (in this case, the area of the hollowed regions in the red sub-pixel region is about 37% of the red sub-pixel region), the slope of the curve thereof varies more flatly than that of the curve when the duty ratio dy of the red sub-pixel electrode units is equal to 1. When the duty ratio dy of the red sub-pixel electrode units is equal to 0.25 (in this case, the area of the hollowed regions in the red sub-pixel region is about 70% of the red sub-pixel region), the slope of the curve thereof consistently varies in a positive manner, which represents that the red sub-pixel electrode units do not generate the gray-scale inversion phenomenon at different drive voltages (i.e., the capability of improving the gray-scale inversion phenomenon is increased significantly). Moreover, when the duty ratio dy of the red sub-pixel electrode units is equal to 0.16 (in this case, the area of the hollowed regions in the red sub-pixel region is about 76% of the red sub-pixel region), the slope of the curve thereof positively varies and is also more smooth, which represents that the image quality can be further improved. In addition, when the characteristic parameter Δnd is 0.62, the electrode pattern of the red sub-pixels also has the tendency that the capability of improving the gray-scale inversion phenomenon increases gradually as the area of the hollowed regions increases. However, to ensure that both the front-view transmittance and the image quality in the oblique-view direction are satisfied, the duty ratio dy of the red sub-pixel electrode units is preferably smaller than or equal to 0.5 (i.e., the area of the hollowed regions in the red sub-pixel region is larger than or equal to 54% of the red sub-pixel region) in a preferred embodiment, and more preferably, the area of the hollowed regions in the red sub-pixel region is larger than or equal to 70% of the red sub-pixel region.

Furthermore, referring to FIG. 6d to FIG. 6f, when the characteristic parameter d/p of the liquid crystal layer doped with the Chiral dopant is 0.222, the capability of improving the gray-scale inversion phenomenon increases gradually as the duty ratio of the electrode patterns in the branch electrodes of the blue sub-pixel electrode units decreases (i.e., the area of the hollowed regions of the blue sub-pixel region increases). Moreover, as the duty ratios of the electrode patterns in the branch electrodes of the green and the red sub-pixel electrode units decrease (i.e., the areas of the hollowed regions of the electrodes increase), the capability of improving the gray-scale inversion phenomenon also increases gradually. In addition, when the characteristic parameter Δnd of the liquid crystal layer doped with the Chiral dopant is 0.62, the capability of improving the gray-scale inversion phenomenon also increases gradually, as the area of the hollowed regions increases.

Therefore, in some embodiments, the numerical ranges of the characteristic parameters of the liquid crystal layer are 0.33<Δnd<0.62 and 0.2≦d/p≦0.36, the ratio of the area of the hollowed regions in the blue sub-pixel region, to the area of the blue sub-pixel region, is larger than or equal to 54%, and when the areas of the hollowed regions in the red and the green sub-pixel regions are not limited, the gray-scale inversion phenomenon generated by the blue sub-pixel electrodes can be improved. In some other embodiments, the ratio of the area of the hollowed regions in the blue sub-pixel region, to the area of the blue sub-pixel region, is larger than or equal to 54%, the ratio of the area of the hollowed regions in the green sub-pixel region, to the area of the green sub-pixel region, is larger than or equal to 54%, and the ratio of the area of the hollowed regions in the red sub-pixel region, to the area of the red sub-pixel region, is larger than or equal to 54%, and in this case, a desired image quality can be achieved. In still some other embodiments, the ratio of the area of the hollowed regions in the blue sub-pixel region, to the area of the blue sub-pixel region, is larger than or equal to 70%, the ratio of the area of the hollowed regions in the green sub-pixel region, to the area of the green sub-pixel region, is larger than or equal to 54%, and the ratio of the area of the hollowed regions in the red sub-pixel region, to the area of the red sub-pixel region, is larger than or equal to 54%, and in this case, a desired image quality can also be achieved.

On the other hand, the arrangement patterns of the red, the green and the blue sub-pixel electrode units of the present invention are not limited to what is described in the aforesaid embodiments. Possible implementations of the red, the green and the blue sub-pixel electrode units of the present invention will be illustrated with examples hereinbelow.

In an embodiment shown in FIG. 7a, regions where the branch electrodes are arranged densely (briefly called “dense electrode regions” hereinbelow) are symmetric about a symmetric center of the sub-pixel electrode unit and extend towards two sides. In an embodiment shown in FIG. 7b, the “dense electrode regions” are asymmetric about the symmetric center of the sub-pixel electrode unit and are located at two sides of the symmetric center. In an embodiment shown in FIG. 7c, the “dense electrode regions” are alternately disposed in the branch electrode regions. In an embodiment shown in FIG. 7d, the “dense electrode regions” are symmetric about the symmetric center of the sub-pixel electrode unit and are located at the two sides of the symmetric center of the sub-pixel electrode unit.

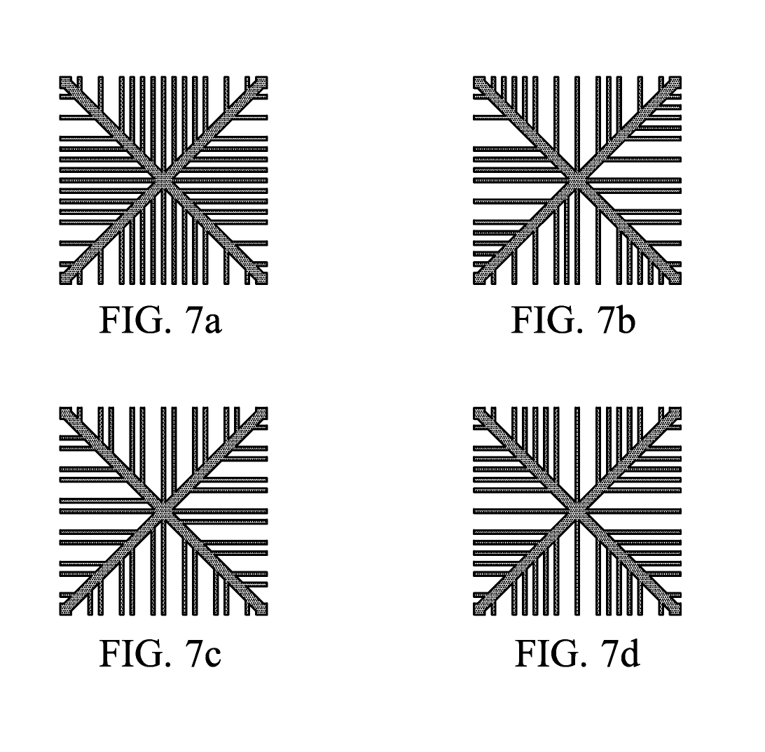

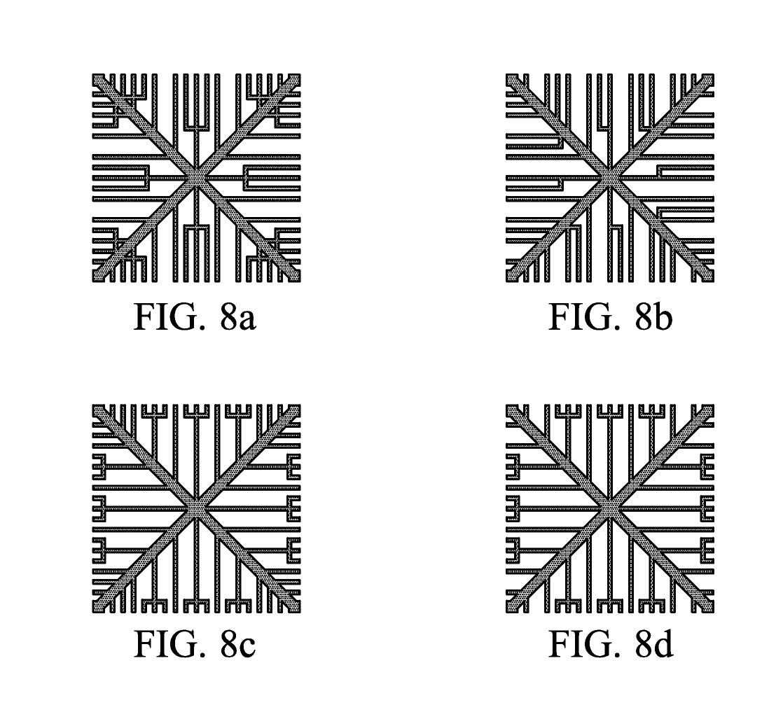

In an embodiment shown in FIG. 8a, the “dense electrode regions” are symmetric about the symmetric center of the sub-pixel electrode unit, and some of the “dense electrode regions” that are adjacent to the symmetric center extend outwards from substantially a center of the branch electrode regions. In an embodiment shown in FIG. 8b, the “dense electrode regions” are alternately arranged in the branch electrode regions and are adjacent to the peripheries of the branch electrode regions. In an embodiment shown in FIG. 8c, the “dense electrode regions” are symmetric about the symmetric center of the sub-pixel electrode unit, with some of the “dense electrode regions” that are adjacent to the symmetric center of the sub-pixel electrode unit being located in periphery regions of the sub-pixel electrode unit and some of the “dense electrode regions” that are away from the symmetric center of the electrode extending from the main electrodes. In an embodiment shown in FIG. 8d, the “dense electrode regions” are symmetric about the symmetric center of the sub-pixel electrode unit, with some of the “dense electrode regions” that are adjacent to the symmetric center of the sub-pixel electrode unit being located in the periphery regions of the electrode.

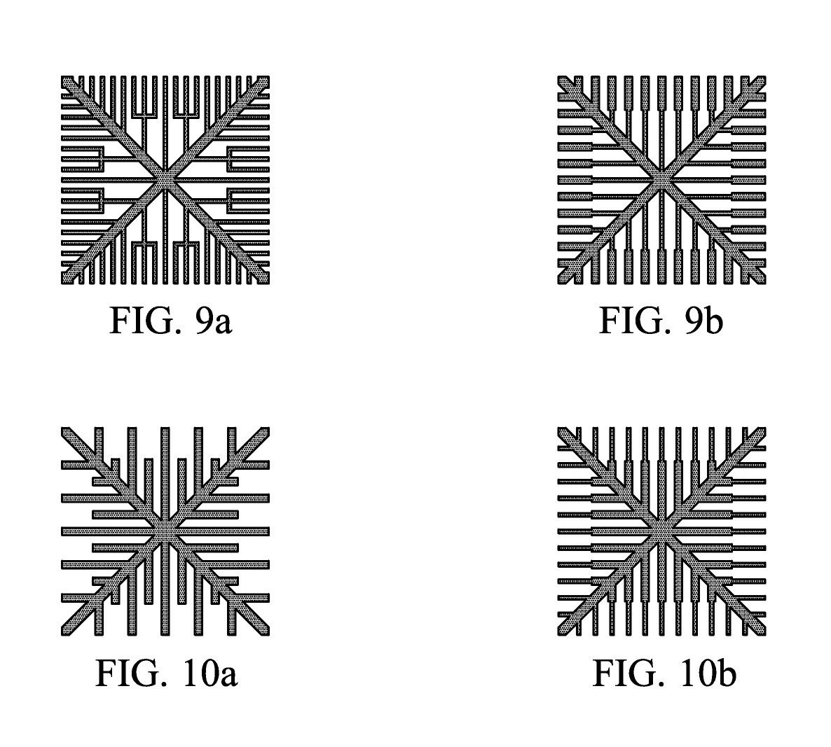

In an embodiment shown in FIG. 9a, the “dense electrode regions” are symmetric about the symmetric center of the sub-pixel electrode unit, with some of the “dense electrode regions” that are adjacent to the symmetric center of the sub-pixel electrode unit extending outwardly from substantially the center of the branch electrode regions and some of the “dense electrode regions” that are away from the symmetric center of the sub-pixel electrode unit extending from the main electrodes. In an embodiment shown in FIG. 9b, ends of the branch electrodes have an increased width, and the “dense electrode regions” are located in the periphery regions of the sub-pixel electrode unit.

In an embodiment shown in FIG. 10a, some of the branch electrodes do not extend to the periphery of the sub-pixel electrode unit, and the “dense electrode regions” are located at substantially the center of the sub-pixel electrode unit. In an embodiment shown in FIG. 10b, the width of the branch electrodes decreases in a direction extending outwards, and the “dense electrode regions” are located at substantially the center of the sub-pixel electrode unit.

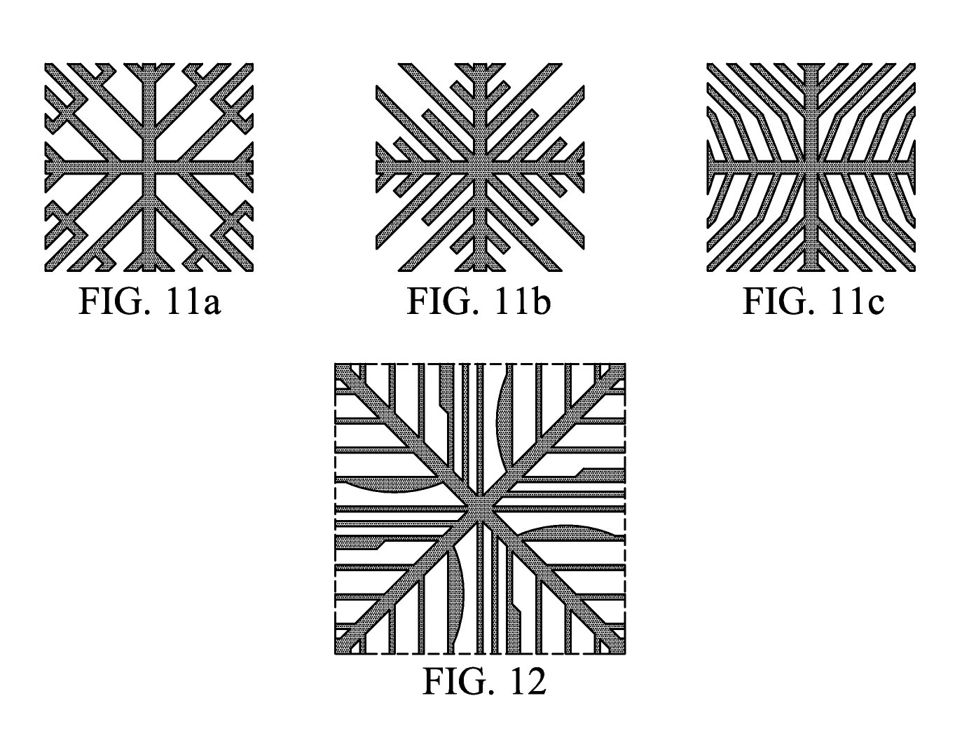

In an embodiment shown in FIG. 11a, the branch electrode regions are substantially in a polygonal form, and the “dense electrode regions” are located at four corners of the sub-pixel electrode unit. In an embodiment shown in FIG. 11b, the branch electrode regions are substantially in a polygonal form, and a region formed by the “dense electrode regions” in the four branch electrode regions together is substantially in a diamond form. In an embodiment shown in FIG. 11c, the branch electrode regions are substantially in a polygonal form, and the branches extending from the horizontal main electrodes are curved. In an embodiment shown in FIG. 12, some of the branch electrodes have an arc-shaped side edge, and some of the branch electrodes are in a pentagonal or hexagonal form.

It shall be noted that, although the branches in each of the branch electrode regions in the aforesaid sub-pixel electrode units are all distributed in the same form, the present invention is not limited thereto. The branch electrodes in a single electrode may be arranged in different forms in the branch electrode regions.

According to the above descriptions, the LCD device of the present invention can improve the gray-scale inversion phenomenon with prior art LCD devices while ensuring that loss of the front-view transmittance is low.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display device, comprising:
a first substrate;
a second substrate, comprising a blue sub-pixel region and a blue sub-pixel electrode unit disposed in the blue sub-pixel region; and
a liquid crystal layer, containing Chiral dopants and disposed between the first and the second substrates, wherein when the numerical ranges of the characteristic parameters of the liquid crystal layer are 0.33≦Δnd≦0.62 and 0.2≦d/p≦0.36, the ratio of the area of the portions in the blue sub-pixel region where the blue sub-pixel electrode unit are not disposed, to the area of the blue sub-pixel region, is larger than or equal to 54%, where Δn represents the birefringence of the liquid crystal material, d represents a thickness of the liquid crystal layer, and p represents a Chiral pitch.

2. The liquid crystal display device as claimed in claim 1, wherein the ratio of the area of the portions in the blue sub-pixel region where the blue sub-pixel electrode unit are not disposed, to the area of the blue sub-pixel region, is larger than or equal to 70%.

3. The liquid crystal display device as claimed in claim 1, wherein the second substrate further includes a green sub-pixel region, and a green sub-pixel electrode unit disposed in the green sub-pixel region, wherein the green sub-pixel electrode unit is adjacent to the blue sub-pixel electrode unit, and the ratio of the area of the portions in the green sub-pixel region where the green sub-pixel electrode unit are not disposed, to the area of the green sub-pixel region, is larger than or equal to 54%.

4. The liquid crystal display device as claimed in claim 3, wherein the second substrate further includes a red sub-pixel region, and a red sub-pixel electrode unit disposed in the red sub-pixel region, wherein the red sub-pixel electrode unit is adjacent to the green sub-pixel electrode unit, and the ratio of the area of the portions in the red sub-pixel region where the red sub-pixel electrode unit are not disposed, to the area of the red sub-pixel region, is larger than or equal to 54%.

5. The liquid crystal display device as claimed in claim 4, wherein the red, the green, and the blue sub-pixel electrode units respectively comprise:
a plurality of main electrodes, extending outwardly from substantially a center of the red, the green, and the blue sub-pixel electrode units to define a plurality of branch electrode regions; and
a plurality of branch electrodes, extending from the main electrodes to the branch electrode regions to form desired electrode patterns, wherein the branch electrode regions of the blue sub-pixel electrode unit comprise electrode patterns of two different duty ratios.

6. The liquid crystal display device as claimed in claim 5, wherein the branch electrode regions of the red, the green, and the blue sub-pixel electrode units comprise different electrode patterns.

7. The liquid crystal display device as claimed in claim 5, wherein the branch electrode regions of the red sub-pixel electrode unit comprise electrode patterns having a single duty ratio.

8. The liquid crystal display device as claimed in claim 4, wherein the red, the green, and the blue sub-pixel electrode units comprise different electrode patterns.

9. A liquid crystal display device, comprising:
a first substrate;
a second substrate, comprising a red sub-pixel region, a green sub-pixel region, a blue sub-pixel region, a red sub-pixel electrode unit, a green sub-pixel electrode unit, and a blue sub-pixel electrode unit, wherein the red, the green, and the blue sub-pixel electrode units are respectively disposed in the red, the green, and the blue sub-pixel regions; and
a liquid crystal layer, containing Chiral dopants and disposed between the first and the second substrates, wherein when the numerical ranges of the characteristic parameters of the liquid crystal layer are 0.33≦Δnd≦0.62 and 0.2≦d/p≦0.36, the ratios of the area of the portions in the red, the green, and the blue sub-pixel regions where the red, the green, and the blue sub-pixel electrode units are not disposed, to the area of the red, the green, and the blue sub-pixel regions, are larger than or equal to 54%, where Δn represents the birefringence of the liquid crystal material, d represents a thickness of the liquid crystal layer, and p represents a Chiral pitch.

10. The liquid crystal display device as claimed in claim 9, wherein the red, the green, and the blue sub-pixel electrode units respectively comprise:
a plurality of main electrodes, extending outwardly from substantially a center of the red, the green, and the blue sub-pixel electrode units to define a plurality of branch electrode regions; and
a plurality of branch electrodes, extending from the main electrodes to the branch electrode regions to form desired electrode patterns, wherein the blue sub-pixel electrode unit comprises electrode patterns of two different duty ratios.

11. The liquid crystal display device as claimed in claim 10, wherein the branch electrode regions of the red, the green, and the blue sub-pixel electrode units comprise different electrode patterns.

12. The liquid crystal display device as claimed in claim 10, wherein the branch electrode regions of the red sub-pixel electrode unit comprise electrode patterns having a single duty ratio.

13. The liquid crystal display device as claimed in claim 9, wherein the red, the green, and the blue sub-pixel electrode units comprise different electrode patterns.

14. The liquid crystal display device as claimed in claim 9, wherein the ratio of the area of the portions in the blue sub-pixel region where the blue sub-pixel electrode unit are not disposed, to the area of the blue sub-pixel region, is larger than or equal to 70%.

15. A liquid crystal display device, comprising:
a first substrate;
a second substrate, comprising a red sub-pixel region, a green sub-pixel region, a blue sub-pixel region, a red sub-pixel electrode unit, a green sub-pixel electrode unit, and a blue sub-pixel electrode unit, wherein the red, the green, and the blue sub-pixel electrode units are respectively disposed in the red, the green, and the blue sub-pixel regions; and
a liquid crystal layer, containing Chiral dopants and disposed between the first and the second substrates, wherein when the numerical ranges of the characteristic parameters of the liquid crystal layer are 0.33≦Δnd≦0.62 and 0.2≦d/p≦0.36, the ratios of the area of the portions in the red, and the green sub-pixel regions where the red, and the green sub-pixel electrode units are not disposed, to the area of the red, and the green sub-pixel regions, are larger than or equal to 54%, and the ratio of the area of the portions in the blue sub-pixel region where the blue sub-pixel electrode unit are not disposed, to the area of the blue sub-pixel region, is larger than or equal to 70%, where Δn represents the birefringence of the liquid crystal material, d represents a thickness of the liquid crystal layer, and p represents a Chiral pitch.

16. The liquid crystal display device as claimed in claim 15, wherein the red, the green, and the blue sub-pixel electrode units respectively comprise:
a plurality of main electrodes, extending outwardly from substantially a center of the red, the green, and the blue sub-pixel electrode units to define a plurality of branch electrode regions; and
a plurality of branch electrodes, extending from the main electrodes to the branch electrode regions to form desired electrode patterns, wherein the blue sub-pixel electrode unit comprises electrode patterns of two different duty ratios.

17. The liquid crystal display device as claimed in claim 16, wherein the branch electrode regions of the red, the green, and the blue sub-pixel electrode units comprise different electrode patterns.

18. The liquid crystal display device as claimed in claim 16, wherein the branch electrode regions of the red sub-pixel electrode unit comprise electrode patterns having a single duty ratio.

19. The liquid crystal display device as claimed in claim 15, wherein the red, the green, and the blue sub-pixel electrode units comprise different electrode patterns.
